(19) United States
(12) Patent Application Publication
(10) Pub. No.: US 2004/0184749 A1
(43) Pub. Date: Sep. 23, 2004

(54) Fiber optic cable and method of manufacturing same

(76) Inventors: Brian G. Herbst, Easley, SC (US); Brett M. Villiger, Greer, SC (US); Kenneth D. Brown, Lyman, SC (US)

Correspondence Address: ECKERT SEAMANS CHERIN & MELLOTT, LLC, ALCOA TECHNICAL CENTER, 100 TECHNICAL DRIVE, ALCOA CENTER, PA, 15069-0001, US

(21) Appl. No.: 10/392,653

(22) Filed: Mar. 20, 2003

(51) Int. Cl. G02B 6/44

(52) U.S. Cl. 385/113

(57) ABSTRACT

A fiber optic cable comprises at least one optical fiber, a tube surrounding the optic fiber, a plurality of strength members positioned adjacent to the tube, and a structure for applying a compressive force to the strength members to couple the strength members to the tube. The structure for applying a compressive force to the strength members can comprise a helically wound tape encompassing the fiber optic cable. A method of constructing a fiber optic cable comprising the steps of providing at least one optical fiber within a tube, positioning a plurality of strength members adjacent to the tube, and applying a compression means to the strength members to couple the strength members to the tube, is also provided.

### FIELD OF THE INVENTION

This invention relates to fiber optic cables and methods of making fiber optic cables.

### BACKGROUND OF THE INVENTION

Fiber optic cables are widely used in communications systems. One type of fiber optic cable, referred to as a unitube fiber optic cable, includes an outer jacket surrounding a tube, which contains one or more optical fibers.

Cold temperatures can adversely affect fiber optic cable, since the temperature coefficient of expansion (TCE), also called the coefficient of thermal expansion (CTE), is quite large for dielectric materials, typically plastics or other non-glass materials, versus the optical fiber. When the cable is exposed to cold temperatures, the cable structural elements contract more than the fiber. In unitube fiber optic cables, there are commonly three approaches to obtaining cold temperature performance. One is to have adequate free space in the tube, the second is to have stiffening rods built into the cable and the third is a combination of free space and stiffening rods.

Typically in a unitube cable there is some free space in the tube, which encases the fiber to allow the fiber to assume a serpentine (sinusoidal) type shape as the cable structure contracts. If this effect is too large it can cause optical attenuation that results in an unusable cable. The tube can be made large enough to accommodate this effect. However, this increases the overall diameter of the cable.

Manufacturers typically use a combination of this free space with either metallic or dielectric strength members whose TCE is very close to that of optical fiber and that have a high modulus (>50 Gpa is typical). These strength members restrict the contraction of the composite cable minimizing the amount of free space required in the unitube. This approach also increases the diameter of the cable, as the profile of the strength members is typically round and the outer jacket must have adequate thickness to prevent the strength members from separating from the jacket when the cable is exposed to bends. This diameter increase has been acceptable in standard loose tube cables but becomes an obstacle when the desire is to have a small diameter fiber optic cable that will be inserted into a micro-duct.

In addition, the use of these strength members can create additional issues. When only two strength members are used, they are typically oriented 180 degrees apart and are located either in the outer jacket of the cable or at the inside wall of the outer jacket. This creates a preferred bend orientation, since the two strength members, with their high modulus, will cause the cable to twist until the strength members are on the neutral axis of bend.

There is a need for a fiber optic cable that can withstand low temperatures and avoids the disadvantages of prior designs.

### SUMMARY OF THE INVENTION

Fiber optic cables constructed in accordance with this invention comprise at least one optical fiber, a tube surrounding the optic fiber, a plurality of strength members positioned adjacent to the tube, and a structure for applying a compressive force to the strength members to couple the strength members to the tube. The structure for applying a compressive force to the strength members can comprise a helically wound tape encompassing the strength members. The helically wound tape can include overlapping windings, and can be a Mylar™ tape.

Each of the strength members can comprise a flexible fiberglass strand. The compressive force is sufficient to prevent movement of the strength members with respect to the tube over a predetermined operating temperature range. In addition, a resin can be provided for binding the strength members to the tube.

In an alternative embodiment, the structure for applying a compressive force to the tube can comprise a pressure-extruded jacket surrounding the strength members.

The invention also encompasses a method of constructing a fiber optic cable comprising the steps of providing at least one optical fiber within a tube, positioning a plurality of strength members adjacent to the tube, and applying a compression means to the strength members to couple the strength members to the tube.

The method can further comprise the step of applying a jacket to the compression means.

### BRIEF DESCRIPTION OF THE DRAWINGS

FIG. 1 is an isometric view of a fiber optic cable constructed in accordance with the invention.

FIG. 2 is an isometric view of a fiber optic cable installation that can include fiber optic cables constructed in accordance with the invention.

### DETAILED DESCRIPTION OF PREFERRED EMBODIMENTS

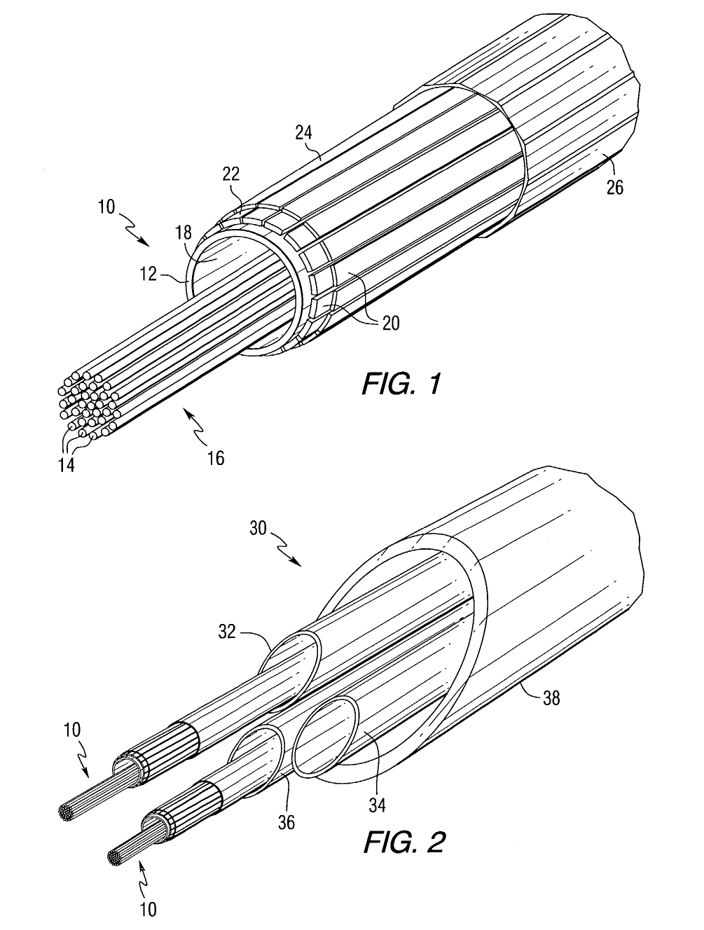

Referring to the drawings, FIG. 1 is an isometric view of a fiber optic cable 10 constructed in accordance with the invention. The fiber optic cable includes a centrally located buffer tube 12. A plurality of optical fibers 14 are positioned within the tube and can be bundled into a bundle 16. A binder can be used to hold the bundle together. A gel can be positioned in the space 18 that is not occupied by optical fibers. A plurality of strength members 20 are positioned adjacent to the periphery of the tube. The strength members can be arranged in a single layer to minimize the cable diameter. Alternatively, multiple layers of strength members could be used. In the embodiment of FIG. 1, two layers 22, 24 of strength members are illustrated. A helically wound tape layer 26 surrounds the strength members and serves as a means for applying a compressive force to couple the strength members to the tube. The compressive force is applied in a radial direction and has sufficient strength to prevent relative movement of the strength members and the buffer tube over a desired operating temperature range. A cable jacket can be applied to the tape layer.

The tape layer can comprise a thermoplastic film such as Mylar™ tape. In FIG. 1, the Mylar™ tape can be seen to be helically wound around the strength members. In one example, a 0.0254 mm (1 mil) Mylar™ tape, having a width of 12.7 mm, can be wound with a 5 mm overlap. However, the turns need not overlap as long as sufficient compressive force can be applied to the strength members to prevent relative movement between the tube and the strength members over a desired operating temperature range. For example, the desired operating temperature range can be −40 to +65° C. While Mylar™ tape has been described for the tape layer, other materials that can be helically wound such as polyimide, Kaladex™, Nomex™ or other commercially available tapes can be used. A ripcord can be provided to permit easy removal of the cable jacket.

In an alternative embodiment, a pressure-extruded jacket can serve as the means for applying compressive force to the strength members, in which case, the tape layer would not be necessary.

The fiber optic cables of this invention utilize strength members that provided some rigidity but are flexible and low in profile, while having a high modulus and having a component material, silica glass, that has a typical thermal coefficient of expansion of 5.5×10⁻⁷/° C. In one embodiment, the strength members comprise Owens Corning (TS3200-EXP04) fiberglass strands (also called ends) having a modulus of 79 Gpa, and a tensile strength of 220 N per end. The cross-sectional area of each load-bearing end is 0.1206 mm². This material is the glass component of fiberglass strands that are commonly used in fiber optic cables. The cross-sectional shape of the fiberglass strength members provides a very low profile that reduces the size of the cable. In addition, the glass component of this material can be encased in a resin that, when exposed to heat, adheres to the components used to construct the cable.

To make the cable, a buffer tube is provided with fiber and gel inside. The buffer tube can be constructed of, for example, polybutylene terephthalate (PBT) or other material. In one embodiment, the buffer tube has an outer diameter of 4.5 mm. Around this tube, ends of the strength members (also called re-enforcement) are stranded at a 500 mm lay length (which can be shorter or longer). If multiple layers of strength members are used, the layers can be wound in opposite directions. The tape is then applied helically at an appropriate tension around this structure to compress the re-enforcement, reducing its profile, and coupling the reinforcement with the tube. The tension will vary with the type of buffer tube material, the type of reinforcement material and the type of tape. A plastic jacket material is then extruded over this core. If a resin is used in combination with the strength members, heat from the jacket can cause the resin to soften and adhere to the buffer tube and the tape layer.

By adjusting the number of ends of the strength element, the composite TCE of the cable can be adjusted to achieve the desired contraction characteristics. The coupling of the strength members and the tube through compression yields a structure that takes advantage of the low TCE of the glass strength members and their high modulus even under compression. Standard fiberglass strength members without the resin component can also provide contraction restriction as long as the cable structure provides adequate compression to the fiberglass.

FIG. 2 is an isometric view of a portion of a fiber optic cable installation 30 that can utilize fiber optic cables constructed in accordance with the invention. The installation of FIG. 2 includes multiple tubes 32, 34 and 36 within an outer tube 38. Each of the inner tubes contains a cable 10 constructed in accordance with FIG. 1. In a typical installation, tube 38 would be buried in the ground and tubes 32, 34 and 36 would be blown into tube 38. Then cables 10 would be blown into tubes 32, 34 and 36.

The method of this invention creates a cable structure that not only provides good tensile performance but also provides resistance to contraction of the plastic components in the design. Fiber optic cables constructed in accordance with this invention can operate over a temperature range of −40 to +65° C. The operating temperature range can be adjusted to be higher or lower by adjusting the glass component.

The fiber optic cables of this invention are particularly suited for use in blown-in installations, wherein air is used to insert the cable into a duct. In such installations, the cable strength members need not be tightly coupled to the cable jacket, as is required for pulled installations.

While the present invention has been described in terms of particular embodiments, it will be apparent to those skilled in the art that various changes can be made to the disclosed embodiments without departing from the scope of the invention as set forth in the following claims.

What is claimed is:

1. A fiber optic cable comprising:
at least one optical fiber;
a tube surrounding the optical fiber;
a plurality of strength members positioned adjacent to the tube; and
means for applying a compressive force to the strength members to couple the strength members to the tube.

2. A fiber optic cable according to claim 1, wherein the means for applying a compressive force to the strength members comprises:
a helically wound tape encompassing the strength members.

3. A fiber optic cable according to claim 2, wherein the helically wound tape includes overlapping windings.

4. A fiber optic cable according to claim 2, wherein the helically wound tape comprises one of:
a Mylar™, polyimide, Kaladex™ or Nomex™ tape.

5. A fiber optic cable according to claim 1, wherein the means for applying a compressive force to the strength members comprises:
a pressure extruded jacket surrounding the strength members.

6. A fiber optic cable according to claim 1, wherein each of the strength members comprises:
a flexible fiberglass strand.

7. A fiber optic cable according to claim 1, wherein the compressive force is sufficient to prevent movement of the strength members with respect to the tube over a predetermined operating temperature range.

8. A fiber optic cable according to claim 7, wherein the predetermined operating temperature range is from −40 to +65° C.

9. A fiber optic cable according to claim 1, further comprising a resin for binding the strength members to the tube.

10. A method of constructing a fiber optic cable comprising the steps of:
providing at least one optical fiber within a tube;
positioning a plurality of strength members adjacent to the tube; and
applying a compression means to the strength members to couple the strength members to the tube.

11. A method according to claim 10, wherein the compression means comprises:
a helically wound tape encompassing the strength members.

12. A method according to claim 11, wherein the helically wound tape includes overlapping windings.

13. A method according to claim 11, wherein the helically wound tape comprises one of:
a Mylar™, polyimide, Kaladex™ or Nomex™ tape.

14. A method according to claim 10, wherein each of the strength members comprises:
a flexible fiberglass strand.

15. A method according to claim 10, wherein the compressive force is sufficient to prevent movement of the strength members with respect to the tube over a predetermined operating temperature range.

16. A method according to claim 15, wherein the predetermined operating temperature range is from −40 to +65° C.

17. A method according to claim 10, further comprising the step of:
applying a jacket to the compression means.

18. A method according to claim 10, wherein the compression means comprises:
a pressure extruded jacket.
